(19) United States
(12) Patent Application Publication
(10) Pub. No.: US 2026/0288927 A1
(43) Pub. Date: Sep. 24, 2026

(54) Governed Release, Compliance Enforcement, and Sovereign Monetization System for Continuity-Based Session Restoration

(71) Applicant: ALEXANDER JOHN BRACKEN, DUBAI (AE)

(72) Inventor: ALEXANDER JOHN BRACKEN, DUBAI (AE)

(21) Appl. No.: 19/693,450

(22) Filed: May 31, 2026

Related U.S. Application Data
(63) Continuation-in-part of application No. 19/418,946, filed on Dec. 13, 2025.
(60) Provisional application No. 63/913,268, filed on Nov. 7, 2025.
(60) Provisional application No. 63/913,146, filed on Nov. 7, 2025.
(60) Provisional application No. 63/914,032, filed on Nov. 8, 2025.
(60) Provisional application No. 63/921,315, filed on Nov. 20, 2025.
(60) Provisional application No. 63/930,668, filed on Dec. 3, 2025.
(60) Provisional application No. 63/930,661, filed on Dec. 3, 2025.

(51) Int. Cl. G06F 21/32; G06F 21/10; G06Q 30/018

(52) U.S. Cl. CPC G06F 21/32; G06F 21/1078; G06Q 30/018

(57) ABSTRACT

A governed release, compliance enforcement, and sovereign monetization system for continuity-based session restoration uses a continuity anchor device comprising a physically integrated secure processing enclave storing non-exportable key material that is not instantiable as, substitutable by, or satisfiable through any remote service or cloud-hosted execution environment. The system controls disclosure of continuity state data according to machine-executable governed release rule sets, generates least-disclosure payloads, enforces safety governance using biometric-derived indicators, implements a decentralized accountless authorization gateway for sovereign monetization, and enforces metered consumption through a cryptographic metering register. Remote authentication, centralized identity providers, and cloud-hosted services are insufficient to authorize restoration absent anchor-local authorization artifact generation using non-exportable key material. All operations are executable in fully offline environments and are hardened against quantum computing attacks through algorithm-agile post-quantum cryptographic primitives.

### STATEMENT REGARDING FEDERALLY SPONSORED RESEARCH

Not Applicable.

### SEQUENCE LISTING

Not Applicable.

### CROSS-REFERENCE TO RELATED APPLICATIONS (CONTINUATION-IN-PART)

This application is a continuation-in-part of U.S. Non-Provisional patent application Ser. No. 19/418,946, filed Dec. 13, 2025, titled “Systems and Methods for Biometric Continuity Token-Based Conversational Continuity Across Interfaced Computing Devices” (the “parent application”). The parent application is incorporated by reference in its entirety. Certain subject matter from the parent application is reproduced herein, and this application further includes continuation-in-part subject matter directed to governed release, compliance enforcement, sovereign monetization, decentralized accountless authorization, physical-anchor enforcement, and tolerance-processing for continuity token derivation.

This application claims the benefit of priority to the following U.S. Provisional patent applications (as identified in the parent application), each of which is incorporated herein by reference in its entirety:
U.S. Provisional Application No. 63/930,668, filed Dec. 3, 2025
U.S. Provisional Application No. 63/930,661, filed Dec. 3, 2025
U.S. Provisional Application No. 63/921,315, filed Nov. 20, 2025
U.S. Provisional Application No. 63/914,032, filed Nov. 8, 2025
U.S. Provisional Application No. 63/913,268, filed Nov. 7, 2025
U.S. Provisional Application No. 63/913,146, filed Nov. 7, 2025

### FIELD OF THE INVENTION

The present disclosure relates generally to computer-implemented biometric security systems and continuity architectures and, more particularly, to systems and methods for governing release, enforcing compliance, and providing sovereign monetization of continuity-based session restoration across multiple computing interfaces through locally derived continuity tokens, encrypted local memory, and locally executed governance, compliance, monetization, and safety operations.

### CROSS-REFERENCE TO RELATED APPLICATIONS

This application is a continuation-in-part of U.S. Non-Provisional patent application Ser. No. 19/418,946, filed Dec. 13, 2025, and claims the benefit of priority to the U.S. Provisional patent applications identified in the cross-reference section above.

### BACKGROUND OF THE INVENTION

Modern interactive computing platforms depend heavily on remote authentication servers, persistent cloud user accounts, centralized identity providers, and cloud-based memory repositories to maintain continuity of services and conversational state across devices. These architectures introduce substantial privacy risks, data leakage concerns, identity theft exposure, platform lock-in dependencies, jurisdictional regulatory conflicts, and service discontinuity failures during network outages, device transitions, or account deactivation events.

Cloud-hosted trusted execution environments and remote secure enclaves, while providing certain cryptographic guarantees, remain subject to network dependency, third-party operator control, remote key escrow requirements, and jurisdictional regulatory access obligations. Cloud key management services, including hardware security modules operated by cloud providers, remain accessible to the cloud provider and subject to lawful compulsion. Such remote execution environments cannot provide the physical possession guarantees, on-device liveness validation, tamper-triggered erasure, or sovereignty assurances required for a continuity anchor architecture in which the user is the exclusive root of trust.

Existing monetization and entitlement systems for AI and continuity services depend on cloud-hosted account infrastructure, centralized subscription management, remote entitlement validation, and persistent identity providers. These dependencies mean that a cloud provider can unilaterally revoke access, modify entitlements, or suspend service without user consent. Prior art does not disclose or suggest a continuity-based monetization architecture in which all authorization, entitlement validation, and access control operations are executed exclusively using non-exportable key material resident in a physical anchor device without any cloud dependency.

Accordingly, there remains a need for a continuity architecture in which the secure processing enclave is physically integrated within a user-associated device, cannot be substituted by any remote or cloud-hosted execution environment, enforces physical possession as a non-negotiable prerequisite to continuity restoration, monetizes continuity-based service access without cloud accounts, and operates with cryptographic primitives resistant to quantum computing attacks over a twenty-year horizon.

Modern interactive computing platforms increasingly rely upon biometric authentication, behavioral pattern recognition, and persistent memory tied to user identity. Existing biometric systems typically transmit identifiers, fingerprints, or biometric data to remote authentication servers, where they are stored and matched. Continuity of conversational context, user preferences, and personal interaction history is similarly managed through persistent cloud accounts, server-managed memory tied to login credentials, or local devices that depend on remote synchronization for restoration.

Such existing approaches have several disadvantages. They require persistent connectivity, which is undesirable in offline, secure, or remote settings. They create privacy and security risks by storing biometric information and sensitive personal data on third-party infrastructure. They introduce latency, jurisdictional, and reliability constraints. Users must often trust external parties to retain, protect, and control access to deeply personal identity data.

Conversational and generative AI systems increasingly span heterogeneous platforms-wearables, vehicles, robotic assistants, fixed installations, AR/VR systems, and remote infrastructure-yet existing solutions force users to re-authenticate or re-establish context with each interface. There is therefore a need for systems and methods that preserve user identity, session, and continuity context locally, transparently, and securely across heterogeneous interactive interfaces.

Prior art in related fields includes wearable body temperature monitoring devices, optical fingerprint sensors, voice biometric systems, behavioral typing dynamics analysis, and continuous authentication protocols based on physiological signals. While such prior art may individually disclose various biometric, sensor, or authentication mechanisms, none of them, alone or in combination, anticipates or renders obvious the integrated continuity architecture described herein.

Specifically, prior art does not disclose or suggest:
local, non-invertible biometric or interaction-signal-derived continuity tokens whose creation, storage, similarity matching, and revocation are entirely device-local;
encrypted local memory indexed to such continuity tokens that is privacy-preserving and offline-capable;
continuity restoration that requires no cloud account, network authentication, or remote credential exchange; and
protocol-based continuity synchronization across heterogeneous interactive interfaces using device-local cryptographic continuity identifiers.

Accordingly, there is an unmet need for biometric continuity systems and methods which combine non-invertible local token derivation, encrypted local memory storage, offline-capable restoration, and protocol-based interface continuity to address the limitations described above.

Accordingly, there remains a need for systems and methods capable of enabling seamless continuity of user interaction across diverse interfaces while preserving privacy through local identity derivation, eliminating reliance on persistent cloud identity architectures, enabling offline operational capability, and supporting both biometric and non-biometric continuity for human users and digital agents.

### SUMMARY OF THE INVENTION

The present disclosure provides a governed release, compliance enforcement, and sovereign monetization system for continuity-based session restoration. The system enables continuity restoration upon re-detection of the continuity token while restricting disclosure of continuity state data according to governed release rule sets enforced by the continuity anchor device using non-exportable key material stored within a physically integrated secure processing enclave that is not instantiable as, substitutable by, or satisfiable through any remote service, cloud-hosted execution environment, or network-accessible trusted execution environment.

The system implements a decentralized accountless authorization gateway in which all authorization request generation, receipt validation, and entitlement enforcement operations are performed locally using non-exportable key material without cloud accounts, remote identity providers, or network-based validation. The system enforces metered consumption through a cryptographic metering register that tracks authorization credit consumption, enforces throttle limits, and detects replay attempts using monotonic counters. The system supports possession quorum verification requiring N of M physical anchor devices to authorize high-privilege operations, successor anchor pre-enrollment for device recovery without cloud dependency, and guardian unlock for dual-anchor authorization of safety lock override.

All cryptographic operations are performed using algorithm-agile cryptographic modules supporting post-quantum primitives including lattice-based, hash-based, and code-based schemes, ensuring that the system remains cryptographically sovereign against quantum computing attacks over a twenty-year horizon without requiring cloud-side key migration or re-enrollment.

In one or more embodiments, the disclosed systems and methods provide privacy-preserving continuity of biometric and session context across diverse computing platforms by combining non-invertible biometric or interaction-signal-derived token derivation, encrypted local memory indexing, offline-capable continuity restoration, and protocol-based synchronization. In doing so, the disclosed systems and methods improve the functioning of computer-based interactive platforms by enabling secure, persistent, and platform-independent user-context continuity without dependency on centralized identity infrastructure.

In one aspect, a continuity anchor device locally acquires biometric or interaction-derived signals, derives a non-invertible continuity token using cryptographic algorithms, and indexes encrypted continuity state in local memory using the continuity token as a reference key. A locally encrypted memory store resident on or controlled by the continuity anchor device contains conversational state, session context, user preferences, conversation history fragments, continuity metadata, or other user-interactive information indexed to the continuity token. The encrypted memory store is configured to operate without persistent cloud connectivity and without external credential management.

The system may operate entirely locally or in decentralized and hybrid configurations, eliminating persistent cloud storage of biometric identifiers or user interaction memory. One or more conversational or user-interface nodes implemented across wearable devices, vehicles, robotic systems, mobile terminals, fixed installations, head-mounted displays, neural interface endpoints, or other interactive platforms exchange ephemeral continuity tokens or token references locally with the continuity anchor device to retrieve session state and resume contextual interaction.

In some embodiments, neural-adjacent or physiological activity patterns detected during low-interaction or sleep states may be buffered locally and used to generate non-explicit continuity assistance outputs upon subsequent waking interactions. In other embodiments, the continuity anchor device may participate in a distributed continuity synchronization protocol defining continuity token message formats, handshake sequences, and reconciliation rules across heterogeneous user-interface nodes.

Aspects, advantages, and features of the disclosure will become apparent from the following detailed description, drawings, and claims.

### BRIEF DESCRIPTION OF THE DRAWINGS

FIG. 1 illustrates a general system architecture showing a continuity anchor device interacting with multiple user-interface nodes through locally derived continuity tokens.

FIG. 2 illustrates a signal flow diagram depicting biometric or interaction-derived signal acquisition, token derivation, encrypted memory indexing, similarity matching, and continuity restoration across user-interface nodes without cloud dependency.

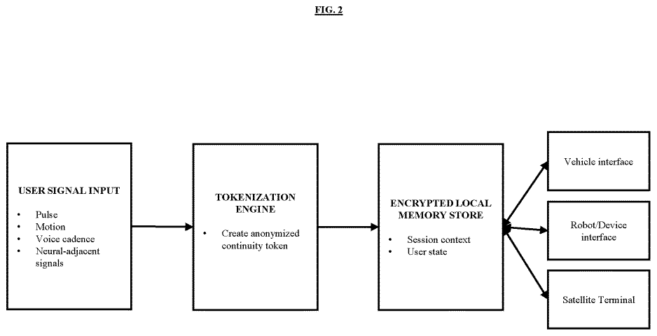

FIG. 3 illustrates an example neural-echo continuity flow showing passive buffering of non-semantic physiological or neural-adjacent signals during sleep or low-interaction states, correlation with waking user interactions, and generation of continuity assistance outputs.

### DETAILED DESCRIPTION OF EMBODIMENTS

The present disclosure provides a technological improvement to privacy-preserving session continuity systems by enabling secure cross-device state restoration without reliance on remote identity servers or persistent biometric storage.

### 6.0 Definitions

As used herein:

“Continuity token” refers to a non-invertible cryptographic value derived from one or more biometric or interaction-derived signals of a user (or digital persona) and a device-specific or environment-specific secret value, and used solely to index locally encrypted continuity state. A continuity token is transient, revocable, and not stored as a raw biometric identifier.

“Neural-adjacent” signal denotes any physiological or electrical measurement obtained from a sensor positioned proximate to, but not penetrating, the user's skin or skull and processed only as numerical time-series data and statistical pattern signals, explicitly excluding any decoded semantic content, dream interpretation, or medical diagnosis.

“Non-semantic interpretation” means statistical or spectral analysis only-no word, memory, intent, or concept is extracted from the signals.

“Memory enhancement signal” refers to a non-verbal output, such as a vibration pattern, tone sequence, light signal, or brief cue, designed to reinforce recall without semantic content.

“Reflection pause” refers to a 0.5-3 second delay in response timing introduced by the system to simulate human thoughtfulness or deliberation.

“Continuity confidence threshold” refers to an acceptance metric, including but not limited to Hamming distance values, probabilistic similarity scoring, or vector distance calculations, used to determine whether two continuity tokens sufficiently correspond to authorize restoration of associated session context.

“Neural interface signal sensor” refers to any sensor capable of non-invasive acquisition of electrophysiological, electro-dermal, or neural-adjacent signals positioned proximate to the skin or cranial surface without penetrating tissue.

“Local authorization register” refers to a secure, device-resident memory record restricting continuity restoration or enhanced feature access to time-delimited intervals or specific usage conditions upon satisfaction of local cryptographic or biometric authorization conditions.

“Safety governance layer” refers to a software, firmware, or hardware module configured to monitor biometric indicators, user consent, and device tamper conditions and to control memory storage, erasure, authorization state, and continuity restoration according to predefined safety policies.

“Behavioral modulation engine” refers to a processing module configured to adapt system response timing, interaction cadence, or presentation characteristics based on biometric or interaction-derived measurements to better align with user behavior or preferences.

“Docking interface” refers to a physical and/or electrical interface configured to provide secure, time-limited communication between the continuity anchor device and an external device or station for authentication, diagnostics, firmware updating, or controlled data access.

“Continuity anchor device” refers to a user-associated computing device or secure virtual environment configured to acquire biometric or interaction-derived signals from a user or digital persona and locally execute continuity token derivation, encrypted memory indexing, similarity matching, and continuity restoration without reliance on external identity infrastructure.

“Non-transitory computer-readable medium” refers to any non-transitory data storage device, including but not limited to random-access memory (RAM), read-only memory (ROM), flash memory, magnetic storage media, or optical disks, and explicitly excludes transitory propagating signals.

“Authorization artifact” refers to a cryptographically verifiable data structure generated within the physically integrated secure processing enclave of the continuity anchor device using non-exportable key material, the artifact being cryptographically bound to (i) the continuity token associated with a requesting session, (ii) a specific requested continuity operation, and (iii) a freshness value comprising at least one of a nonce, monotonic counter value, or time-window parameter, such that the artifact is non-transferable to other sessions or operations, is rendered invalid upon successful verification, and is not generatable outside the physical continuity anchor device boundary without access to the non-exportable key material.

“Non-exportable key material” refers to cryptographic key data stored within a physically integrated secure processing enclave of the continuity anchor device in a manner that prevents extraction, transmission, or derivation of the key data outside the enclave boundary through any software, firmware, hardware, or remote interface, including privileged operating system access, debug interfaces, external bus monitoring, and network-accessible management interfaces, such that the key material cannot be mirrored, escrowed, re-hosted, or backed up by any cloud-hosted key management service, third-party key escrow service, or remote hardware security module.

“Synthetic identity signature” refers to a deterministic cryptographic value derived from non-biological interaction state data associated with a digital persona, autonomous agent, or virtual identity construct, including but not limited to agent behavioral fingerprints, session state hashes, or cryptographic persona certificates, used as a continuity token source in the absence of biometric signal input.

“Governed release rule set” refers to a machine-executable set of disclosure constraints specifying conditions under which continuity state data or continuity state fragments may be released to heterogeneous user-interface nodes, including but not limited to disclosure level constraints, temporal constraints, jurisdictional compliance constraints, consent conditions, and entitlement verification conditions, the governed release rule set being evaluated and enforced exclusively by the continuity anchor device using non-exportable key material.

“Continuity anchor execution environment” refers to the continuity anchor device together with its physically integrated secure processing enclave and non-exportable key material, configured to execute governed release enforcement, authorization artifact generation, least-disclosure payload generation, safety governance enforcement, and audit artifact generation under exclusive cryptographic control, the continuity anchor execution environment being not instantiable as, substitutable by, or satisfiable through any remote service, cloud-hosted execution environment, or network-accessible trusted execution environment.

“Physical possession,” as used to characterize a prerequisite to continuity restoration or governed release, means presence of the physical continuity anchor device within a predefined proximity to the user or to a paired node, verified by one or more proximity or possession verification mechanisms, including but not limited to: near-field communication, ultra-wideband ranging, Bluetooth Low Energy received signal strength indication with anti-relay timing checks, capacitive contact sensing, inertial co-movement correlation between the device and the user, or docking interface presence; and successful completion of on-device liveness validation within the physically integrated secure processing enclave.

“Metering register” refers to a secure, device-resident data structure stored within the secure processing enclave of the continuity anchor device that tracks authorization credit balances, records monotonically incrementing consumption counters indexed to the continuity token, enforces per-session and per-interval throttle limits, and maintains a rolling revocation window for replay detection, such that all metering state is exclusive to the continuity anchor device and not readable, writable, or recoverable by any remote service.

“Possession quorum” refers to a threshold authorization condition requiring that a predefined minimum number N of a predefined set M of registered physical continuity anchor devices each independently generate a valid authorization artifact using their respective non-exportable key material, and that all N authorization artifacts be presented and verified within the continuity anchor execution environment of the primary anchor before a high-privilege operation is authorized, such that no single anchor device alone can authorize the operation and no remote service can substitute for any quorum participant.

“Successor anchor” refers to a physical continuity anchor device that has been pre-enrolled by the primary continuity anchor device using a physical co-presence enrollment protocol, wherein the successor anchor stores a cryptographically derived recovery credential generated using the primary anchor's non-exportable key material during co-presence enrollment, such that the successor anchor can authorize re-derivation of continuity tokens indexed to the primary anchor's continuity state after loss or destruction of the primary anchor, without requiring any cloud-hosted recovery service or third-party key escrow.

“Algorithm-agile cryptographic module” refers to a cryptographic processing component within the secure processing enclave of the continuity anchor device that is configured to execute cryptographic operations using interchangeable algorithm implementations selectable from a set comprising classical algorithms, post-quantum algorithms, and hybrid classical plus post-quantum algorithms, such that the module can transition between algorithm implementations without requiring re-enrollment of biometric signals, re-derivation of continuity tokens from raw signals, or cloud-side key migration, thereby providing cryptographic sovereignty over a multi-decade operational horizon.

### 6.1 System Architecture

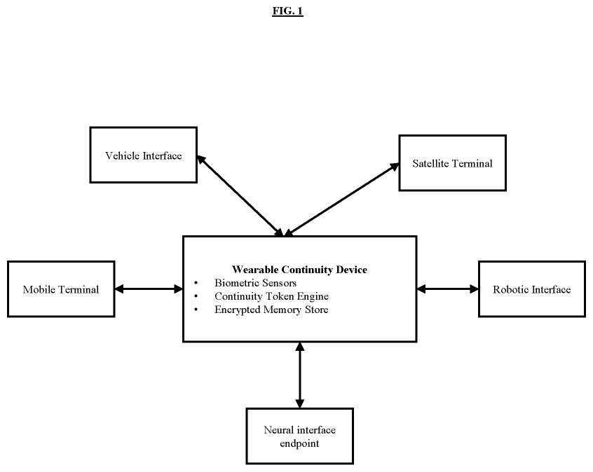

As shown in FIG. 1, the system comprises a continuity anchor device associated with a user. In many embodiments, the continuity anchor device is implemented as a wearable device such as a pendant, bracelet, ring, or head-mounted unit. In other embodiments, the continuity anchor device may be embedded into a vehicle, mobile phone, robotic system, fixed installation, neural interface endpoint, or other computing device. The continuity anchor device communicates with one or more conversational user-interface nodes through wired interfaces, wireless interfaces, optical interfaces, near-field interfaces, or any combination thereof.

The continuity anchor device includes one or more biometric or interaction-derived sensors, such as:
pulse or heart rate sensors;
thermal or skin temperature sensors;
inertial measurement units, accelerometers, or gyroscopes;
electro-dermal or galvanic skin response sensors;
neural-adjacent electrophysiological sensors;
microphones or vocal cadence analyzers;
capacitive, touch, or typing rhythm sensors;
gaze, motion, or additional interaction pattern detectors.

The continuity anchor device executes an identity derivation engine that processes raw sensor data locally to generate a continuity token. This token represents an anonymized biometric or interaction profile. Raw biometric identifiers and feature vectors need not be stored in non-volatile memory or transmitted externally.

A locally encrypted memory store within or under the control of the continuity anchor device indexes conversational state, session context, user preferences, conversation history fragments, continuity metadata, or other user-interactive information to the continuity token. The encrypted memory store is configured to operate without persistent cloud connectivity and without external credential management.

Example: In a vehicular use case, the continuity anchor device (worn as a pendant or integrated into the steering column) detects pulse and motion signals while the user is driving, derives a continuity token, and stores a conversation about navigation preferences, calendar entries, and music selections in encrypted memory keyed to that token.

### 6.2 Continuity Restoration

Upon reconnection of the continuity anchor device to any conversational user-interface node, the identity derivation engine acquires fresh biometric or interaction-derived signals and determines whether a previously derived continuity token has been re-detected following one or more interruption events, such as:
device transitions;
power loss or reboot;
network interruptions;
idle periods or lapse of user interaction;
removal and re-association of the continuity anchor device with the user.

Upon successful token recognition, the continuity restoration engine retrieves associated session state and re-establishes the contextual conversational environment without requiring network authentication, credential entry, or cloud retrieval of stored memory. Restoration may include resuming a prior dialog, reinstating user-specific preferences, restoring contextually relevant memory, or activating optional continuity assistance signals.

Example: After a two-hour idle period, the continuity anchor device re-detects the continuity token upon sensing a valid live-user biometric pattern and restores a conversation on a mobile terminal, optionally adjusting response latency to match the user's recent typing rhythm.

### 6.3 Conversational User-Interface Nodes

As shown in FIG. 1, conversational user-interface nodes may operate on any computing platform capable of exchanging user-interactive data with the continuity anchor device, including but not limited to:
wearable devices;
vehicles and autonomous transport platforms;
robotic systems or assistive robotics;
mobile terminals or phones;
fixed installations, kiosks, or retail terminals;
entertainment systems or audiovisual terminals;
satellite communication terminals or spacecraft consoles;
head-mounted displays or spatial projection systems;
neural interface endpoints;
cloud-hosted conversational or AI services.

These nodes do not persist long-term personal identity data and rely solely on ephemeral continuity tokens or token references exchanged locally with the continuity anchor device to obtain continuity context. Session data may be streamed from the continuity anchor device or reconstructed locally by the user-interface node from received continuity tokens, depending on operational mode and policy.

Example: In a vehicle-to-robot transition, the continuity anchor device hands off an ongoing conversation about daily tasks from the car's infotainment system to a home robotic assistant without transmitting raw biometric data to either system.

### 6.4 Token Derivation and Encryption

The continuity token is generated using local cryptographic derivation mechanisms incorporating:
biometric or interaction signal preprocessing and normalization;
statistical entropy quantization or feature extraction;
rolling feature vector construction over sliding windows;
cryptographic hashing functions, such as SHA-256 or similar primitives.

Tokens are transient, revocable, and non-invertible, ensuring that personally identifiable biometric or neural signals cannot be reconstructed from the stored continuity data. The continuity anchor device may rotate or refresh continuity tokens periodically or in response to security policy events.

The encrypted memory store uses symmetric or asymmetric cryptographic encryption to prevent unauthorized extraction of session or identity contextual data. Neither raw biometric data nor full feature vectors are stored in non-volatile memory or transmitted externally. In some embodiments, the continuity anchor device employs hardware-backed cryptographic acceleration or secure enclave isolation to perform token derivation and encrypted memory indexing without exposing key material to the device's general-purpose processor or operating system.

### 6.4.1 Example Token Generation Algorithm

In one embodiment, the identity derivation engine samples pulse rate and motion data at predetermined sampling frequencies. Pulse rate is sampled at 32-128 Hz and motion from a three-axis accelerometer is sampled at 50-200 Hz. The engine computes, over a sliding time window of 5-60 seconds, one or more of:
(i) an average pulse rate;
(ii) a pulse rate variance;
(iii) an average acceleration magnitude; and
(iv) an acceleration variance.

Each feature is normalized into a bounded numeric range and quantized into a fixed number of bits (for example, 8-12 bits per dimension). The quantized values are concatenated into a feature string and combined with a device-specific secret value stored in a secure enclave. A cryptographic hash function (for example, SHA-256) is applied to the resulting concatenation to produce a fixed-length cryptographic value, a predetermined subset of which is truncated to form the continuity token.

### 6.4.1.1 Worked Example—Continuity Token Generation and Matching

In one illustrative example:
A pulse sensor reports heart rate samples with an average of 72.4 bpm and variance of 4.1.
A three-axis accelerometer reports motion magnitudes averaging 0.032 g with variance of 0.009.

The identity derivation engine forms a feature vector F=[72.4, 4.1, 0.032, 0.009] and normalizes it to a bounded interval, yielding F′. Each component is quantized into fixed-bit integer representation Q. The quantized values are concatenated into a feature string S. S is concatenated with a device-specific secret value D to form X═S∥D.

A cryptographic hash H=SHA256 (X) is computed, and a predetermined subset of bits is truncated to produce the continuity token T. Upon subsequent operation, new biometric samples produce a re-derived vector yielding a second token T′. A token comparison module computes the Hamming distance HD (T, T′). When HD (T, T′) is less than or equal to a predetermined threshold (for example, 10 bits out of 128 bits), the system treats T and T′ as a match and authorizes retrieval of the associated session context.

This process ensures robustness to transient biometric fluctuations while preventing reconstruction of underlying biometric measurements from the continuity token.

In informal prototype testing conducted entirely offline using pulse-rate and motion-derived signals, the continuity token system consistently exceeded a same-user matching rate of zero point nine five across repeated sessions, with low false acceptance, without reliance on any network-attached identity service.

### 6.4.2 Example Token Matching

When a new continuity token is generated, a token comparison module computes a similarity metric between the new token and one or more previously stored reference tokens. In one embodiment, the similarity metric is a Hamming distance between token bit strings. In other embodiments, the similarity metric may comprise correlation coefficients, Euclidean or cosine distance in an embedding space, or probabilistic matching against statistical reference distributions.

If the similarity metric between the new token and a stored reference token satisfies the continuity confidence threshold, the system treats the tokens as a match and authorizes retrieval of associated session context. If the similarity metric does not satisfy the threshold for any stored reference token, the system denies continuity restoration and may initiate revocation, re-enrollment, or alternative authorization procedures.

### 6.4.3 Continuity State Machine Operation

In some embodiments, continuity management is performed using a multi-state execution model. The system operates according to the following states:
Enrollment State—the continuity anchor device acquires biometric or interaction-derived signals and generates an initial continuity token associated with a new encrypted session memory entry.
Active Continuity State—the system continuously refreshes token derivation for ongoing session verification and may update encrypted session context incrementally.
Matching State-upon reconnection, idle interruption, or interface transition, the continuity anchor device computes a re-derived continuity token and compares it to stored tokens using similarity metrics.
Authorization State-if confidence thresholds are met, associated session context is restored or partially restored.
Revocation State-if mismatch or tamper detection occurs, the associated continuity token and its indexed memory state are invalidated and optionally erased.
Re-Enrollment State-upon user consent or security reset, new continuity tokens are generated and continuity resumes.

This state-machine logic is executed locally on the continuity anchor device without reliance on centralized servers or cloud identity services.

A pseudocode representation:
WHILE system_active:
   SAMPLES←acquire_sensor_window( )
   F←normalize_features (SAMPLES)
   Q←quantize (F)
   X←concat (Q, device_secret)
   TOKEN_new←-hash (X)
   IF stored_tokens empty THEN
      store (TOKEN_new, session_state)
      state←ACTIVE
   ELSE
      match_found←FALSE
      FOR each TOKEN_old in stored_tokens:
         IF HAMMING (TOKEN_new, TOKEN_old)<=threshold THEN
         restore_session (TOKEN_old)
         state←AUTHORIZED
         match_found←TRUE
         BREAK
      IF NOT match_found THEN
         deny_continuity( )
         state←REVOKE
END WHILE

### 6.5 Offline Operation

The continuity anchor device and user-interface nodes may function independently of persistent network connectivity. All continuity restoration operations can be executed locally or via direct device-to-device communication mechanisms without cloud dependency, cloud account authentication, centralized identity-provider participation, remote credential exchange, or persistent server-side continuity storage.

The system can operate indefinitely in offline mode while still providing continuity restoration based solely on locally stored tokens and encrypted memory. Continuity assistance cues, such as subtle prompts or memory reinforcement signals, do not generate any persistent data outside the continuity anchor device.

Example: In a remote area without network coverage, the continuity anchor device restores a session from local memory upon reboot and resumes interaction with a nearby offline terminal.

### 6.6 Additional Embodiments—Cognitive Continuity and Liveness Verification

### 6.6.1 Neural Echo/Passive Cognitive Continuity

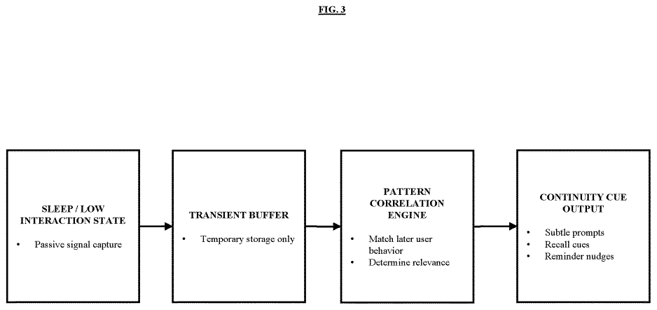

In some embodiments illustrated in FIG. 3, the continuity anchor device may passively detect non-semantic physiological or neural-adjacent signal patterns during periods of reduced interaction or sleep states.

Such signals are:
temporarily buffered in local volatile memory;
summarized into non-semantic statistical measures;
not semantically interpreted or decoded;
not transmitted to any remote system.

Upon subsequent waking interactions, current user activity patterns may be correlated with buffered activity signatures to determine potential contextual relevance. When a correlation threshold is satisfied, the system may generate non-explicit continuity assistance outputs selected from:
subtle prompts;
recall-reinforcement cues;
memory enhancement signals;
nudge notifications.

These outputs do not constitute interpretation of dream content or direct decoding of user thoughts, but serve solely to reinforce continuity between subconscious activity and waking task completion.

In one embodiment, the continuity anchor device samples physiological signals such as heart rate variability and skin conductance at a low sampling frequency (e.g., 0.5-4 Hz) during periods when the user is detected as inactive or sleeping. The sampled values are stored in a circular buffer and statistically summarized using non-semantic measures (mean, variance, dominant frequency component, or autocorrelation coefficients) over rolling windows of 30-90 minutes.

Upon waking, when the user initiates an interaction, the continuity anchor device may reference the most recent sleep-period summary to issue a brief contextual cue (for example, a calendar reminder, a recall hint, or a soft activity prompt). At no point are the buffered physiological signals transformed into decoded semantic content or used for medical analysis.

### 6.6.2 Liveness and Anti-Spoofing Verification

In some embodiments, the continuity anchor device applies liveness validation to ensure continuity authorization is based on genuine live-user biometric sampling rather than spoof replication. Liveness measures may include:
challenge-response testing of pulse-rate variability over randomized sampling windows;
sensor fusion cross-validation between pulse, motion, thermal, and electro-dermal signals to detect physiological coherence;
detection of temporal anomalies inconsistent with continuous biological signal generation;
detection of static or replayed signal patterns indicative of recording attacks.

If spoofing or replay patterns are detected, continuity matching is denied, revocation protocols are initiated, and memory entries may be invalidated or erased according to safety policies.

### 6.7 Privacy and Data Control

No personally identifiable biometric data, raw neural recordings, dream content, or unprocessed sensor streams are stored permanently or transmitted externally. All continuity tokens, buffers, memory indexing, and continuity restoration operations are executed locally under control of the continuity anchor device.

User memory may be selectively retained, erased, or purged based on user preferences, inactivity thresholds, or regulatory requirements. No cloud-based biometric identity storage or centralized session continuity servers are required.

### 6.8 Security and Tamper Protection

The continuity anchor device can include tamper detection circuits, encrypted secure enclaves, write-once memory fusing mechanisms, and hardware integrity checks configured to trigger cryptographic erasure of stored continuity keys, encrypted memory data, and associated continuity state upon detection of unauthorized intrusion or removal.

In docking-enabled embodiments, any external docking station or host device participating in controlled data access is further configured to cryptographically erase temporary session keys, cached continuity data, and authentication credentials upon termination of the session, ensuring that continuity-relevant information does not persist on intermediate or external systems.

### 6.9 Commercial and Software Integration

The system may operate with local transaction authorization mechanisms in which micro-transaction or local access triggers initiate temporary enhanced continuity features or session privileges without dependency on centralized accounts, remote identity servers, or cloud-based validation services.

Transactions are generated, validated, and recorded locally. Authorization updates are written exclusively to the local authorization register tied to the continuity token. Variable transaction parameters may include session duration, feature access, or other operational enhancements.

In payment-enabled embodiments, the continuity anchor device generates transaction authorization requests, verifies cryptographic receipts or zero-knowledge proofs, and updates a local time-locked authorization register.

Reflection pauses between 0.5 and 3 seconds may be applied to responses to simulate human thoughtfulness, enhance perceived quality, and avoid masking latency. These local transaction authorization mechanisms function independently of biometric identity derivation and remain subordinate to the continuity confidence threshold and safety governance layer.

### 6.9.1 Micro-Transaction Validation Protocol

In embodiments supporting micro-transactions or local access unlocks, the transaction-based access control module executes a cryptographic validation protocol independent of cloud identity systems. A representative flow includes:
Step A: The continuity anchor device generates a locally issued transaction request containing a time stamp, session continuity token hash reference, feature unlock identifier, and transaction request parameters based on local policy.
Step B: A local or optionally connected payment processing subsystem returns a cryptographic payment confirmation receipt including a transaction validation signature or proof.
Step C: The continuity anchor device validates the receipt using signature verification or zero-knowledge proof techniques without exposure of raw biometric data or full continuity tokens.
Step D: Upon validation, the continuity restoration engine updates a local time-locked authorization register to permit enhanced session functionality or extended access intervals.
Step E: All transaction generation, validation, and authorization operations are executed locally; no continuity state, raw biometric data, or user memory is transmitted externally.

### 6.10 Clinical Disclaimer

The disclosed system does not provide medical diagnosis, mental health evaluation, dream interpretation, or neural therapeutic treatment. Neural-adjacent detection serves only as a passive contextual continuity support mechanism and does not decode neurological content or cognitive intent.

### 6.11 Policy-Adaptive Continuity Operation

In certain embodiments, the biometric continuity token system applies one or more jurisdictional, enterprise, or regulatory policy profiles that dynamically govern the operation of continuity token processing, session state retention, authorization verification, or metadata disclosure behaviors of the continuity anchor device and associated user-interface nodes.

Policy profiles may specify that continuity operations execute in one or more selectable compliance modes including:
a) a fully private local-operation mode in which continuity tokens and session memory are generated, stored, matched, and erased exclusively on the continuity anchor device without any external reporting of continuity state or metadata;
b) a regulated compliance mode in which a subset of cryptographically verifiable session metadata or authorization records are escrowed, encrypted, or transmitted to a designated compliance validation endpoint without exposure of raw biometric signals, neural-adjacent signals, or unencrypted continuity tokens; or
c) a hybrid operation mode in which token derivation and session continuity remain local while authorization or audit confirmation receipts are periodically synchronized to compliance infrastructure systems according to jurisdictional or enterprise rules.

Selection or switching of policy profiles may be configured automatically based on device geolocation, regulatory instruction broadcasts, enterprise security directives, or user-authorized overrides. In all cases, the continuity token derivation, encrypted memory indexing, similarity matching, and continuity restoration operations remain governed by the safety governance layer and continuity confidence threshold of the continuity anchor device.

### 6.12 Protocol-Based Continuity Synchronization

In certain embodiments, the system implements a distributed continuity synchronization protocol defining structured message formats, cryptographic continuity identifiers, handshake sequences, reconciliation rules, and state restoration ordering logic for transferring and synchronizing continuity tokens, session metadata, or partial conversational context across heterogeneous user-interface nodes and the continuity anchor device.

The protocol governs:
transmission of continuity token references or cryptographic hashes between user-interface nodes and the continuity anchor device;
cryptographically authenticated session-state reconciliation requests and acknowledgments;
conflict resolution handling between partial or concurrent interaction streams originating from different interface nodes;
session restoration staging for continuation of conversational flow following device transitions or network interruptions.

The protocol operates independently of any single interface platform and may be implemented within hardware, firmware, software applications, or virtualized environments across devices operated by differing vendor ecosystems or ownership domains. Protocol execution does not require centralized identity infrastructure, persistent cloud accounts, or external session management servers.

### 6.13 Digital Persona and Autonomous Agent Continuity

In certain embodiments, continuity tokens may be derived not only from biometric or interaction-derived human signal sources but additionally from digital persona signatures, behavioral interaction profiles, or autonomous agent state fingerprints representing persistent conversational, operational, or behavioral identity attributes of an artificial intelligence agent, virtual persona, autonomous co-pilot, or non-biological digital identity construct.

Accordingly, the continuity system supports session continuity not only between computing platforms associated with human users, but also between interacting digital agents, co-piloting assistants, virtual personas, or neural-simulation-derived identity constructs wherein continuity tokens may be derived from digital persona signatures, behavioral interaction profiles, autonomous agent state fingerprints, or other persistent conversational identifiers.

The encrypted memory indexing and continuity restoration engines process such persona-derived continuity tokens using the same similarity metrics and threshold confidence mechanisms to preserve persistent conversational context across computing platforms for both human and non-human identity entities.

### 6.14 Hardware-Neutral Anchor Implementations

In certain embodiments outside the sovereign physically anchored embodiments described in Sections 6.15 through 6.25, the continuity anchor device may be implemented as a physical wearable apparatus, mobile terminal, implanted computing module, vehicle-integrated computing environment, robotic subsystem node, neural interface gateway, distributed trusted execution container, or fully virtualized continuity service environment running on commodity general-purpose computing infrastructure. In each case, the continuity token derivation, encrypted memory indexing, similarity matching, and authorization operations are executed within a designated continuity anchor execution environment, which may correspond to dedicated hardware, firmware-isolated execution contexts, secure software enclaves, or trusted execution environments running on broader computing platforms.

Such implementations encompass both dedicated hardware anchors and software-instantiated anchors operating within secure enclaves, trusted execution environments, containerized compute nodes, peer-to-peer mesh routers, or ledger-bound cryptographic entities. In all embodiments, the continuity token derivation, encrypted memory indexing, similarity matching, and continuity restoration operations are executed within the designated continuity anchor execution environment without dependency on centralized identity providers, cloud-hosted account systems, or remote credential authorities.

Notwithstanding the foregoing, in the embodiments described in Sections 6.15 through 6.24 and Section 6.25 and recited in the claims of the present continuation-in-part as requiring a physically integrated secure processing enclave, non-exportable hardware-bound key material, an authorization artifact generator, physical possession, or sovereign monetization, the continuity anchor device must be implemented as a physical continuity anchor device having a physically integrated secure processing enclave; in such embodiments, software-only implementations, cloud-hosted implementations, and remote-service implementations of the continuity anchor device are expressly excluded from the scope of those embodiments.

### 6.15 Cloud-Sovereign Anchor Architecture and Physical Integration

In preferred embodiments, the secure processing enclave of the continuity anchor device is physically disposed within and exclusively integrated into the physical continuity anchor device, and is not instantiable as, substitutable by, or satisfiable through any remote service, cloud-hosted execution environment, network-accessible trusted execution environment, or any enclave whose execution is initiated, managed, or terminable by a third-party operator or remote infrastructure provider.

The physical integration requirement means that the secure processing enclave shares a physical substrate with the biometric sensor array and tamper detection circuitry of the continuity anchor device. Tamper events detected by the tamper detection circuitry initiate immediate cryptographic erasure within the enclave without traversing any network interface. Liveness signals acquired by the biometric sensor array are validated within the enclave without external transmission.

Remote attestation evidence alone-including remote TEE attestation certificates, cloud HSM proof-of-presence, and network-based cryptographic proofs of enclave integrity—is insufficient, by itself and absent satisfaction of on-device physical possession and liveness conditions, to authorize continuity restoration, governed release, or any safety governance action.

Continuity restoration requires physical possession of the continuity anchor device and satisfaction of on-device liveness conditions evaluated within the physically integrated secure processing enclave, plus generation of a cryptographic authorization artifact within the enclave using non-exportable key material that cannot be reproduced by any remote service.

The non-exportable key material of the continuity anchor device cannot be backed up, escrowed, mirrored, or re-hosted by any cloud-hosted key management service, third-party key escrow service, remote hardware security module, or network-accessible management interface. Cloud-hosted signing services, remote attestation services, and network-accessible trust registries are insufficient to satisfy the authorization artifact requirement unless the artifact is generated within the physically integrated secure processing enclave using the non-exportable key material resident in the physical continuity anchor device.

In embodiments of Sections 6.15 through 6.24, the continuity anchor execution environment is implemented as a physical continuity anchor device with a physically integrated secure processing enclave, and excludes software-only or remote instantiations for purposes of authorization artifact generation, governed release enforcement, metering register control, possession quorum verification, and safety governance operations. This clarification applies to the cloud-exclusion limitations of this continuation-in-part and does not modify the broader continuity anchor device definition in Section 6.0, which remains as incorporated from the Parent Application.

### 6.16 Governed Release Controller and Least-Disclosure Payload Generation

The governed release controller executed by the continuity anchor execution environment controls disclosure of continuity state data using at least one machine-executable governed release rule set specifying at least one disclosure constraint. Responsive to the controller, the least-disclosure payload generator produces payloads comprising at least one of: a cryptographic hash or digest of continuity state content; a cryptographically protected metadata token; a redacted continuity fragment omitting required reconstruction elements such that the fragment is insufficient to reconstruct full session context; or a cryptographic pointer to ciphertext continuity state, wherein retrieval of plaintext continuity state requires verification of an anchor-local authorization artifact.

The governed release controller may apply staged disclosure levels including at least a digest-only level, a redacted fragment level, and a zero-disclosure level returning a zero-knowledge proof that no continuity state entry indexed to the continuity token is releasable under the governed release rule set. All disclosure is restricted such that plaintext reconstruction requires an anchor-local authorization artifact generated using non-exportable key material under exclusive control of the continuity anchor execution environment.

### 6.17 Continuity Freeze Controller, Compliance Profiles, and Audit Artifacts

The continuity freeze controller enforces cryptographically locked freeze states during safety events, compliance investigations, or jurisdictional audits. Exit from a freeze state requires anchor-local authorization artifact generation using non-exportable key material verified within the continuity anchor execution environment. Remote commands, centralized account recovery, and external identity authority actions are insufficient to lift a freeze state absent anchor-local cryptographic authorization.

The cryptographic audit artifact generator creates tamper-evident, append-only audit logs comprising anchor-generated digital signatures and hash-chain links to prior records. The system dynamically selects governed release rule sets based on geolocation, enterprise security instructions, or user overrides validated under anchor-local authorization. All operations are executable offline without network dependency.

### 6.18 Decentralized Accountless Authorization Gateway and Metering Rail

The continuity anchor execution environment implements a decentralized accountless authorization gateway comprising: a local encrypted authorization register storing time-bounded entitlement states indexed to the continuity token; a transaction request generation module creating local authorization requests referencing cryptographic derivatives of the continuity token and service access parameters; a cryptographic receipt verification module validating signatures or zero-knowledge proofs locally using non-exportable key material without transmitting continuity material or biometric data externally; and an access control enforcement module updating the time-locked authorization state and conditionally enabling or disabling enhanced continuity-based service access privileges.

Remote account login, passkey authentication, centralized identity provider authentication, centralized entitlement confirmation, external enterprise policy enforcement, cloud-hosted key management services, and external key escrow authorization are each insufficient by themselves to enable privileges absent anchor-local receipt verification using non-exportable key material and local authorization register update.

The metering register, stored exclusively within the secure processing enclave, tracks authorization credit balances indexed to the continuity token, records monotonically incrementing consumption counters for each authorization event, enforces per-session and per-interval throttle limits defined by the economic policy engine, and maintains a rolling revocation window for detecting replay attempts. Upon depletion of authorization credits, access to enhanced continuity features is suspended until the metering register is recharged through a locally validated cryptographic receipt. In one embodiment, the metering register enforces a consumption counter using a hardware-backed monotonic counter within the secure processing enclave, wherein each successful authorization event atomically increments the counter and binds the increment to the authorization artifact, such that any attempt to present a previously consumed authorization artifact is rejected by counter comparison.

Local fraud signals are generated when liveness validation fails in combination with a receipt mismatch condition, indicating a potential spoofing or replay attack. Upon detection, the metering register is locked, the continuity token is rotated, and the safety governance layer is notified.

In one illustrative example of metering register operation, a continuity anchor device is enrolled with an initial credit balance of one hundred standard restoration units. The economic policy engine defines three entitlement tiers: Tier 1 (basic session restoration, one credit per restoration event), Tier 2 (extended memory depth restoration, three credits per restoration event), and Tier 3 (cross-device restoration with agent resources, seven credits per restoration event). The metering register maintains a hardware-backed monotonic consumption counter initialized to zero at enrollment.

Upon each successful restoration event, the following operations execute atomically within the secure processing enclave: (i) the current credit balance is decremented by the tier-appropriate credit cost; (ii) the monotonic consumption counter is incremented by one; (iii) the authorization artifact for the current restoration is bound to the current counter value as its nonce field; (iv) the counter value is permanently incremented such that it cannot be decremented or reset by any software, firmware, or remote interface. A restoration event presenting an authorization artifact whose nonce field contains a counter value less than or equal to the current counter value is rejected as a replay attempt without decrementing the credit balance.

When the credit balance reaches zero, access to Tier 2 and Tier 3 features is suspended and only Tier 1 basic restoration remains available. To recharge the metering register, the user obtains a signed pricing manifest from a payment processing subsystem, the manifest specifying a credit top-up value and signed using the payment provider's private key. The continuity anchor device validates the manifest signature using a locally stored verification key, and upon successful validation atomically updates the credit balance within the secure processing enclave without network connectivity. In one embodiment, the per-interval throttle limit is set to a maximum of ten restoration events per sixty-minute window; if this limit is reached, restoration requests are queued until the window expires regardless of remaining credit balance, providing rate limiting against automated scraping or replay attacks. All metering state-credit balance, consumption counter, throttle window, and revocation register—is stored exclusively within the secure processing enclave and is not readable, writable, or recoverable by any remote service.

### 6.18.1 Metering Register Worked Example

In one illustrative embodiment, the metering register operates as follows. Upon initial entitlement grant, the metering register is initialized with an authorization credit balance of 720 credits representing 30 days of enhanced continuity access at a consumption rate of 24 credits per day. The hardware-backed monotonic consumption counter C is initialized to zero within the secure processing enclave.

Each restoration event consumes 1 credit from the authorization credit balance and atomically increments the consumption counter C by 1. The generated authorization artifact incorporates the current value of C as a bound nonce field, bound to (i) the continuity token hash reference, (ii) the requested restoration operation identifier, and (iii) a timestamp. Upon successful verification, the enclave increments C to C+1, such that any subsequent presentation of an artifact containing the consumed value of C fails verification by counter comparison.

Per-session throttle enforcement records the timestamp T_last of the most recent successful authorization event. If a new authorization request arrives within a minimum interval of 60 seconds of T_last, the metering register returns a throttle rejection without decrementing the credit balance and without generating an authorization artifact, preventing brute-force restoration attempts from depleting the credit balance.

At day 15, with 360 credits remaining, the user presents a cryptographic receipt from a payment processing subsystem. The receipt is validated locally using the non-exportable key material of the continuity anchor device using zero-knowledge proof verification without exposure of raw biometric data or continuity token material. Upon successful validation, the metering register increments the authorization credit balance by 720 credits representing an additional 30-day entitlement period, and records the receipt identifier in the rolling revocation window to prevent replay of the same receipt.

At day 30, the credit balance reaches zero. The access control enforcement module automatically suspends enhanced continuity service features, downgrading entitlement to the base free tier. Continuity restoration continues to function at the free tier level; only enhanced features—extended memory depth, cross-device restoration privileges, and agent resources—are suspended. No network connectivity is required at any point during this process; all metering register operations execute exclusively within the secure processing enclave using non-exportable key material.

In one fraud detection scenario, liveness validation fails due to detection of a static replayed biometric pattern, coinciding with a receipt that does not correspond to any valid payment event in the local validation record. The metering register detects the concurrent liveness failure and receipt mismatch, generates a local fraud signal, locks the metering register, rotates the continuity token, and notifies the safety governance layer. The metering register lock is releasable only upon successful re-enrollment of a valid liveness-verified continuity token using the non-exportable key material of the continuity anchor device, without requiring network connectivity or cloud-side fraud resolution services.

### 6.19 Safety Governance Layer and Cryptographic Erasure Control

The safety governance layer executed by the continuity anchor execution environment continuously evaluates safety state data associated with continuity identity operations. It requires active user consent prior to enabling continuity restoration, monitors for predefined inactivity, distress, tamper, or absence conditions using biometric or interaction-derived signals against temporal, coherence, or liveness thresholds, and triggers the cryptographic erasure control module to initiate irreversible destruction of encrypted continuity memory, continuity tokens, or authorization state by cryptographic wipe of required decryption or validation keys.

In one embodiment, a distress condition is detected when heart rate variability falls below a predefined lower threshold or exceeds a predefined upper threshold for a sustained interval of at least thirty seconds, and electro-dermal activity simultaneously exceeds a configurable conductance threshold, indicating a safety-relevant anomaly condition for continuity governance. Consent is revalidated at intervals or upon interruption events; safety events delete recordings, invalidate continuity tokens, and prevent restoration until cryptographically authenticated anchor-local reset using non-exportable key material. Remote policy, centralized recovery, cloud-hosted governance servers, or external commands are insufficient absent anchor-local authorization.

The system enforces safety lock states, continuity freeze during investigation or audit intervals, and override only via cryptographically authenticated reset verified using non-exportable key material within the secure processing enclave. Override actions are recorded in encrypted safety-event logs. The governance layer supersedes monetization authorization states, adapts local jurisdictional rule profiles based on geolocation or signed artifacts without cloud dependency, and isolates the anchor upon tamper detection. All operations execute locally without network connectivity as a prerequisite.

### 6.20 Possession Quorum, Successor Anchor, and Guardian Unlock

In certain embodiments, high-privilege continuity operations including safety lock override, successor anchor enrollment, and governed release of full session context require satisfaction of a possession quorum condition comprising N of M registered physical continuity anchor devices each independently generating a valid authorization artifact using their respective non-exportable key material, and all N authorization artifacts being presented and verified within the continuity anchor execution environment of the primary anchor. No single anchor device alone can authorize a quorum-required operation. No remote service can substitute for any quorum participant. Cloud-hosted multi-party computation services and remote hardware security modules are insufficient to satisfy a possession quorum condition.

Successor anchor enrollment is performed using a physical co-presence enrollment protocol in which the primary anchor and the successor anchor are physically present and each generates a mutually binding enrollment artifact using their respective non-exportable key material. The successor anchor stores a cryptographically derived recovery credential generated using the primary anchor's non-exportable key material during co-presence enrollment. Upon loss or destruction of the primary anchor, the successor anchor can authorize re-derivation of continuity tokens indexed to the primary anchor's continuity state using the recovery credential, without requiring any cloud-hosted recovery service, third-party key escrow, or network connectivity. Successor anchor enrollment requires physical presence and cannot be performed remotely.

Guardian unlock enables a designated guardian anchor device-pre-enrolled using the physical co-presence protocol—to authorize release of a safety lock state using dual-anchor authorization, requiring both the primary anchor and the guardian anchor to each generate a valid authorization artifact. The dual-anchor authorization artifacts are verified within the primary anchor's secure processing enclave. Remote command signals, cloud-hosted governance servers, and centralized account recovery are insufficient to substitute for either anchor's physical authorization artifact.

### 6.21 Economic Policy Engine and Tiered Entitlement Management

The economic policy engine executes within the continuity anchor execution environment and manages tiered entitlement states governing access to enhanced continuity features. Entitlement tiers may include but are not limited to: basic session restoration; extended memory depth restoration; cross-device restoration privileges; resurrection window entitlements enabling restoration after extended inactivity; and agent resources entitlements governing AI processing cadence and capability levels.

Entitlement states are stored in the local authorization register indexed to the continuity token and are not readable, modifiable, or recoverable by any remote service. The economic policy engine selects and enforces entitlement tiers based on: locally validated cryptographic receipts or zero-knowledge proofs received from payment processing subsystems; dynamic pricing rules stored in signed offline pricing manifests validated using non-exportable key material; engagement cadence thresholds computed from interaction-derived signals; and time-bounded entitlement grants enforced by the metering register.

Signed offline pricing manifests are cryptographically signed policy documents delivered to the continuity anchor device and validated using non-exportable key material, specifying pricing rules, tier definitions, and entitlement parameters applicable during offline operation without requiring network connectivity for policy enforcement. Policy updates are delivered as signed manifest revisions; the continuity anchor device validates each revision using the anchor's non-exportable key material before applying updated pricing rules, ensuring that no unauthorized pricing modification can be imposed by any remote service.

All economic policy enforcement, entitlement validation, and tier selection operations are executed locally within the continuity anchor execution environment using non-exportable key material. Centralized subscription management services, cloud-hosted entitlement validation APIs, and remote pricing servers are insufficient to modify or override entitlement states absent locally validated anchor-level authorization.

### 6.22 Post-Quantum Cryptographic Hardening and Algorithm Agility

In certain embodiments, all cryptographic functions executed by the continuity anchor execution environment-including continuity token derivation, authorization artifact generation, audit artifact signing, zero-knowledge proof generation, metering register operations, possession quorum verification, and successor anchor enrollment-utilize post-quantum cryptographic primitives resistant to quantum computing attacks. Supported primitives include but are not limited to lattice-based schemes such as CRYSTALS-Kyber for key encapsulation and CRYSTALS-Dilithium for digital signatures, hash-based schemes such as SPHINCS+ for stateless signatures, code-based schemes, and hybrid classical plus post-quantum modes combining conventional algorithms with post-quantum algorithms for defense in depth.

The algorithm-agile cryptographic module within the secure processing enclave supports runtime selection of cryptographic algorithms from the supported set without requiring re-enrollment of biometric signals, re-derivation of continuity tokens from raw signals, or migration of non-exportable key material outside the enclave boundary. Algorithm agility enables the continuity anchor device to transition to stronger post-quantum primitives as quantum computing capabilities advance over a twenty-year operational horizon, without cloud-side key migration, re-issuance of credentials by a cloud authority, or service interruption. All algorithm transitions are performed exclusively within the secure processing enclave using non-exportable key material.

In one hybrid embodiment, authorization artifact signing operations compute both an ECDSA signature using a classical elliptic curve key and a Dilithium signature using a post-quantum key, concatenating both signatures into the authorization artifact. Verification requires successful verification of both signatures, ensuring that compromise of either the classical or the post-quantum component alone is insufficient to forge a valid authorization artifact. This hybrid mode ensures security against both classical and quantum adversaries simultaneously.

### 6.23 Zero-Knowledge Proof and Verifiable Computation Compatibility

In certain embodiments, the continuity anchor execution environment generates zero-knowledge proofs demonstrating compliance with governed release rule sets, absence of anomaly conditions, or satisfaction of entitlement conditions without disclosing restricted continuity state, biometric signals, non-exportable key material, or pricing rule parameters. Zero-knowledge proofs, succinct non-interactive arguments of knowledge (SNARKs/STARKs), and successor verifiable computation systems are supported as proof generation mechanisms, enabling external parties to verify compliance without gaining access to protected continuity state.

In one embodiment, the zero-disclosure level of the governed release controller is implemented using a commitment scheme wherein the continuity anchor execution environment generates a zero-knowledge proof demonstrating that no continuity state entry indexed to the presented continuity token satisfies the current governed release rule set for release, without revealing the continuity state contents, the continuity token, the entitlement state, or any governed release rule parameters. The proof is generated exclusively within the secure processing enclave using non-exportable key material as the commitment randomness.

### 6.24 Multi-User, Family, and Organizational Delegation

In certain embodiments, the governed release rule set supports granular delegation of sub-tokens with revocable, time-bound, and scope-limited rights for multi-user, family, or organizational sharing while preserving individual sovereignty. Delegation is consent-chained across physical anchor devices and may include individual veto rights or collective freeze capabilities. All delegation actions require anchor-local authorization artifact generation using non-exportable key material and are recorded in the encrypted audit log. Sub-token derivation uses a cryptographic hash function applied to a concatenation of the primary continuity token, a delegation scope descriptor, and a time-bounded validity window, producing a derived token cryptographically bound to the delegating anchor's non-exportable key material. Revocation is enforced by the continuity anchor device maintaining a delegation revocation registry within the secure processing enclave; any sub-token appearing in the registry is denied restoration access regardless of continuity confidence threshold evaluation.

### 6.25 Tolerance-Processing for Continuity Token Derivation

In certain embodiments, similarity-based matching for continuity restoration is performed on stabilized intermediate representations of the underlying source inputs rather than directly on the cryptographic output of an unmodified hash function. In embodiments requiring tolerance to bounded variation in the source inputs of a continuity token, similarity evaluation is performed prior to final cryptographic commitment, within the physically integrated secure processing enclave of the physical continuity anchor device, on stabilized intermediate representations of the source inputs.

Such stabilized intermediate representations may be produced by one or more of: a fuzzy extractor; a secure sketch combined with helper data and cryptographic re-hashing; a locality-sensitive hashing function applied to a normalized and quantized feature vector; an error-correcting code applied to a quantized feature representation in combination with stored helper data; or an enclave-internal stabilized feature representation derived from the normalized and quantized source inputs. In such embodiments, the cryptographic continuity token represents a stabilized output produced after such tolerance processing, rather than a raw output of a cryptographic hash applied directly to unstable biometric, behavioral, or state-derived inputs. In other embodiments, the similarity metric may be applied directly to the normalized and quantized feature representations of the source inputs, with a final cryptographic hash applied only after a successful similarity match has been determined within the physically integrated secure processing enclave. These embodiments collectively avoid reliance on similarity comparisons performed solely on the avalanche output of an unmodified cryptographic hash function applied to slightly varying source inputs.

All helper data, stabilization parameters, error-correcting code parameters, and locality-sensitive hashing parameters used to produce stabilized intermediate representations are stored exclusively within the physically integrated secure processing enclave of the physical continuity anchor device, are not transmitted externally, and are not exportable through any cloud-hosted service, remote attestation interface, or third-party operator. Tolerance processing is performed entirely within the physical device boundary of the continuity anchor device, consistent with the cloud-sovereign anchor architecture of Section 6.15 and the algorithm-agile cryptographic module of Section 6.22.

In a representative non-limiting example consistent with the foregoing tolerance-processing embodiments, a feature vector V representing one or more biometric or interaction-derived characteristic dimensions is normalized and quantized within the physically integrated secure processing enclave to produce a quantized feature string S. A stabilized intermediate representation R is produced from S using one or more of the tolerance-processing techniques described above (such as application of a secure sketch with helper data, locality-sensitive hashing of the quantized feature representation, or enclave-internal feature stabilization). The concatenation R∥D, where D is a non-exportable hardware-bound device-specific secret value retained within the physically integrated secure processing enclave, is computed and a cryptographic hash function (such as SHA-256 or a post-quantum hash construction selected by the algorithm-agile cryptographic module of Section 6.22) is applied, producing a digest from which a predetermined number of bits forms the continuity token T. A subsequent redetermination using the same tolerance-processing path produces T′. A Hamming distance HD (T, T′) less than or equal to a predetermined threshold (for example, 12 bits out of 128 bits) satisfies the continuity confidence threshold defined in Section 6.0. Alternatively, the similarity metric may be evaluated within the physically integrated secure processing enclave on the stabilized intermediate representations R and R′ directly, with the cryptographic continuity token derived only following successful intermediate-level matching.

The tolerance-processing operations described in this Section 6.25 are performed entirely within the physically integrated secure processing enclave of the physical continuity anchor device. The non-exportable hardware-bound key material described in Section 6.15 cooperates with the tolerance-processing techniques described in this Section 6.25 such that all stages of continuity token derivation-including normalization, quantization, stabilization through fuzzy-extractor, secure-sketch, locality-sensitive-hashing, or error-correcting-code techniques, concatenation with the device-specific secret value, and final cryptographic commitment—are performed exclusively within the physical device boundary, with no exposure of intermediate representations, helper data, or stabilization parameters to any cloud-hosted service, remote attestation interface, or third-party operator.

### ALTERNATIVE EMBODIMENTS

The present disclosure may be implemented across a wide range of hardware and software substrates including but not limited to:
wearable pendants, bracelets, rings, or head-mounted devices;
implanted computing modules or medical-grade devices;
hybrid biometric authentication accessories;
vehicle-mounted biometric terminals and infotainment systems;
robotic interface relays and home automation hubs;
satellite uplink identity modules and spaceborne computing systems;
secure virtualization containers or distributed ledger-anchored identities.

Communication methods may include wired ports, wireless RF links, Bluetooth Low Energy (BLE) communications, satellite uplinks, optical transceivers, bio-electrical couplings, or other physical or wireless channels.

Cryptographic derivation algorithms may include but are not limited to hashing, rolling entropy derivation, zero-knowledge proof tokenization, homomorphic encryption-assisted comparisons, or secure enclave-processed biometric transformations.

The present disclosure may be implemented across a wide range of hardware and software substrates including wearable pendants, bracelets, rings, head-mounted devices, implanted computing modules, vehicle-mounted terminals, robotic interface relays, satellite uplink identity modules, and secure virtualization containers. Cryptographic derivation algorithms may include hashing, rolling entropy derivation, zero-knowledge proof tokenization, homomorphic encryption-assisted comparisons, post-quantum primitives, or secure enclave-processed biometric transformations. The system is expressly adaptable to future cryptographic proof systems, secure hardware technologies, communication protocols, and non-semantic behavioral signals across any device or software form factor.

### CONCLUSION

The present disclosure enables secure and privacy-preserving continuity of interactive computing sessions across distributed devices without dependence on centralized cloud identity infrastructures or storage of personal biometric identifiers. By employing local continuity token derivation, encrypted local memory indexing, offline-capable continuity restoration, and protocol-based synchronization, the disclosed technology advances the state of the art of biometric continuity systems and reduces dependence on external network infrastructure. The present disclosure enables secure, privacy-preserving, cloud-sovereign, and compliance-enforced continuity of interactive computing sessions across distributed devices without dependence on centralized cloud identity infrastructures, cloud-hosted key management services, or third-party key escrow. By employing local continuity token derivation, encrypted local memory indexing, governed least-disclosure release, decentralized accountless monetization, safety governance, possession quorum verification, successor anchor recovery, and post-quantum hardening with algorithm agility, the disclosed technology advances the state of biometric and interaction-based continuity computing systems for both human and digital personas while preserving complete user sovereignty against centralized infrastructure dependency over a twenty-year operational horizon.

1. A governed release, compliance enforcement, and sovereign monetization system for continuity-based session restoration across heterogeneous user-interface nodes, comprising:
a) a continuity anchor device comprising a physically integrated secure processing enclave storing non-exportable key material in hardware-enforced isolated memory, the secure processing enclave being not instantiable as, substitutable by, or satisfiable through any remote service, cloud-hosted execution environment, or network-accessible trusted execution environment, and the non-exportable key material being not mirrored, escrowed, or re-hosted by any cloud-hosted key management service or third-party key escrow service;
b) an identity derivation engine configured to derive a non-invertible continuity token from one or more biometric or interaction-derived signals, or from digital persona signatures, behavioral interaction profiles, or autonomous agent state fingerprints, combined with a device-specific or environment-specific secret value stored within the physically integrated secure processing enclave;
c) an encrypted continuity state repository stored locally within or under cryptographic control of the continuity anchor device, indexed to the continuity token, wherein decryption and release of plaintext continuity state require generation of an anchor-local authorization artifact using non-exportable key material under exclusive cryptographic control of the continuity anchor device;
d) a governed release controller executed by the continuity anchor device and configured to control disclosure of continuity state data using at least one machine-executable governed release rule set specifying at least one disclosure constraint;
e) a least-disclosure payload generator configured to generate, responsive to the governed release controller, a least-disclosure continuity payload comprising at least one of: (i) a cryptographic hash or digest of continuity state content, (ii) a cryptographically protected metadata token, (iii) a redacted continuity fragment omitting at least one reconstruction element selected from semantic content, credential material, and cryptographic decryption material such that the fragment is insufficient to reconstruct full session context, or (iv) a cryptographic pointer to ciphertext continuity state requiring an anchor-local authorization artifact for plaintext retrieval;
f) a decentralized accountless authorization gateway implemented by the continuity anchor device and configured to generate local authorization requests referencing cryptographic derivatives of the continuity token, validate cryptographic receipts or zero-knowledge proofs using non-exportable key material without transmitting continuity material or biometric data externally, and update a local time-locked authorization register indexed to the continuity token, wherein remote account login, passkey authentication, centralized identity provider authentication, and cloud-hosted key management services are insufficient by themselves to update the authorization register absent locally validated cryptographic authorization;
g) a metering register stored exclusively within the physically integrated secure processing enclave and configured to track authorization credit balances, record monotonically incrementing consumption counters indexed to the continuity token, enforce per-session throttle limits, and maintain a rolling revocation window for replay detection, such that all metering state is not readable, writable, or recoverable by any remote service; and
h) a safety governance layer configured to monitor biometric indicators, user consent, and device tamper conditions, to require active user consent prior to enabling continuity restoration, to detect predefined distress, inactivity, tamper, or absence conditions, and to initiate irreversible cryptographic erasure of stored continuity tokens and encrypted continuity memory upon satisfaction of a safety revocation threshold, wherein all safety governance operations are executed locally and remote commands, centralized account recovery, cloud-hosted governance servers, and external identity authority actions are insufficient to authorize continuity restoration or release a safety lock state absent anchor-local authorization artifact generation using non-exportable key material,
wherein the system enables continuity restoration upon re-detection of a continuity token for which a similarity metric satisfies a predefined continuity confidence threshold following an interruption event, while restricting disclosure according to the governed release rule set; wherein remote attestation evidence, by itself and absent satisfaction of on-device physical possession and liveness conditions, does not authorize continuity restoration or governed release; and wherein the non-exportable key material cannot be extracted, mirrored, escrowed, or re-hosted by any third-party operator, cloud-hosted service, or network-accessible interface.

2. The system of claim 1, wherein the governed release controller implements at least one of: (i) communicating at least a portion of the least-disclosure continuity payload or an auditable release artifact to an optional compliance validation endpoint, wherein validation by the endpoint is insufficient by itself to authorize continuity restoration or governed release absent anchor-local authorization artifact generation; or (ii) applying staged disclosure levels including at least a digest-only level, a redacted fragment level, and a zero-disclosure level generating a zero-knowledge proof that no continuity state entry indexed to the continuity token is releasable under the governed release rule set.

3. The system of claim 1, wherein network connectivity is not required as a prerequisite to authorizing governed release, continuity restoration, or monetization authorization, all operations being executable in a fully offline mode.

4. The system of claim 1, further comprising at least one of: (i) a continuity freeze controller configured to enforce a cryptographically locked freeze state during at least one of a safety event, compliance investigation, jurisdictional audit, or tamper detection condition, wherein no remote command is sufficient by itself to lift the freeze state absent verification of an anchor-local authorization artifact within the physically integrated secure processing enclave; (ii) a tamper response module configured, upon a tamper detection condition, to perform cryptographic invalidation of the continuity token and encrypted continuity memory with no external recovery path absent anchor-local authorization; (iii) a local fraud signal generator configured to generate fraud signals when liveness validation fails in combination with a receipt mismatch condition, wherein upon fraud signal generation the metering register is locked, the continuity token is rotated, and the safety governance layer is notified, all without network dependency; or (iv) a continuity restoration gate configured to deny continuity restoration upon detection of a local fraud signal until anchor-local authorization re-establishes integrity, with rotation of the continuity token.

5. The system of claim 1, wherein at least one of: (i) the auditable release artifact is recorded to an encrypted audit log comprising append-only records each including an anchor-generated digital signature and a hash-chain link to a prior record, providing tamper-evident modification detection; or (ii) the governed release controller prohibits export of full plaintext continuity state content outside the continuity anchor device while permitting export of least-disclosure continuity payloads, and wherein any user-interface node receiving continuity state data receives only least-disclosure payloads insufficient to reconstruct full session context absent anchor-local decryption material.

6. The system of claim 1, wherein at least one of: (i) the decentralized accountless authorization gateway enforces time-bounded entitlement states that expire without network renewal, such that entitlement is maintained by locally validated cryptographic receipts and the metering register without requiring cloud-hosted subscription management; or (ii) the metering register enforces one-time artifact validity by maintaining a monotonically incrementing hardware-backed nonce counter within the physically integrated secure processing enclave, wherein each authorization event atomically increments the counter and binds the increment to the authorization artifact, such that presentation of a previously consumed artifact is rejected by counter comparison without requiring network connectivity.

7. The system of claim 1, wherein the safety governance layer implements at least one of: (i) detection of a distress condition by evaluating at least one of heart rate variability measurements or electro-dermal activity measurements against predefined thresholds for a sustained interval, and initiation of cryptographic erasure of stored continuity tokens and encrypted continuity memory upon detection; or (ii) supersession of the decentralized accountless authorization gateway and the metering register, such that active entitlement states and credit balances are overridden and suspended upon detection of a safety revocation event.

8. The system of claim 1, further comprising a possession quorum module configured to require N of M registered physical continuity anchor devices to each independently generate a valid authorization artifact using their respective non-exportable key material before authorizing a high-privilege operation, wherein no single anchor device alone can authorize the operation and no remote service can substitute for any quorum participant, and wherein high-privilege operations requiring possession quorum authorization include at least one of safety lock override, successor anchor enrollment, or governed release of full session context beyond the redacted fragment disclosure level.

9. The system of claim 1, further comprising at least one of: (i) a successor anchor enrollment module configured to execute a physical co-presence enrollment protocol in which the continuity anchor device and a successor anchor device are physically co-located and each generates a mutually binding enrollment artifact using their respective non-exportable key material, wherein successor anchor enrollment cannot be performed remotely and wherein cloud-hosted recovery services and third-party key escrow are insufficient to substitute for physical co-presence enrollment; (ii) a successor recovery module configured, upon loss or destruction of the continuity anchor device, to authorize re-derivation of continuity tokens through a successor anchor device using a recovery credential generated during a prior physical co-presence enrollment between the continuity anchor device and the successor anchor device, without requiring cloud-hosted recovery services, network connectivity, or third-party key escrow; or (iii) a guardian unlock module configured to enforce dual-anchor authorization for release of a safety lock state, requiring both the continuity anchor device and a pre-enrolled guardian anchor device to each generate a valid authorization artifact, wherein remote command signals, cloud-hosted governance servers, and centralized account recovery are insufficient to substitute for either anchor's physical authorization artifact.

10. The system of claim 1, further comprising an economic policy engine executing within the continuity anchor execution environment using non-exportable key material and configured to perform at least one of: (i) managing tiered entitlement states governing access to enhanced continuity features including at least one of extended memory depth restoration, cross-device restoration privileges, resurrection window entitlements, or agent resources entitlements; (ii) selecting and enforcing entitlement tiers based on locally validated cryptographic receipts and dynamic pricing rules stored in signed offline pricing manifests validated using non-exportable key material, such that centralized subscription management services, cloud-hosted entitlement validation APIs, and remote pricing servers are insufficient to modify entitlement states absent locally validated anchor-level authorization; or (iii) validating signed offline pricing manifests as cryptographically signed policy documents specifying pricing rules, tier definitions, and entitlement parameters applicable during offline operation, wherein no unauthorized pricing modification can be imposed by any remote service absent anchor-local validation.

11. The system of claim 1, wherein all cryptographic operations executed by the continuity anchor device utilize an algorithm-agile cryptographic module configured to execute cryptographic operations using interchangeable algorithm implementations selectable from a set comprising classical algorithms, post-quantum algorithms, and hybrid classical plus post-quantum algorithms, the module supporting runtime algorithm selection without re-enrollment of biometric signals, re-derivation of continuity tokens from raw signals, or cloud-side key migration; and wherein the algorithm-agile cryptographic module further implements at least one of: (i) post-quantum algorithms comprising at least one of CRYSTALS-Kyber for key encapsulation, CRYSTALS-Dilithium for digital signatures, or SPHINCS+ for stateless signatures, the module enabling transition to stronger post-quantum primitives over a twenty-year operational horizon without service interruption or cloud-side re-issuance; or (ii) hybrid mode authorization artifact generation computing both a classical digital signature and a post-quantum digital signature, concatenating both signatures into the authorization artifact, wherein verification requires successful verification of both signatures such that compromise of either component alone is insufficient to forge a valid artifact.

12. The system of claim 1, wherein the continuity anchor execution environment is compatible with zero-knowledge proofs, succinct non-interactive arguments of knowledge, and successor verifiable computation systems for proof generation without disclosing restricted continuity state, biometric signals, or non-exportable key material to external verifiers.

13. The system of claim 1, wherein the continuity anchor device implements at least one of: (i) a profile selection engine configured to select or modify the governed release rule set based on at least one of geolocation, enterprise security instruction, user-authorized override validated under anchor-local authorization using non-exportable key material, or locally stored jurisdictional compliance profile data, without reliance on cloud-based policy authority servers; or (ii) operation under dynamically selectable policy profiles comprising at least a fully private local-operation mode, a regulated compliance mode, and a hybrid operation mode, wherein safety governance enforcement, governed release enforcement, monetization operations, and locally validated cryptographic authorization remain anchor-local regardless of the selected policy profile.

14. The system of claim 1, wherein each user-interface node receiving continuity state data or authorization artifacts is treated as untrusted, and wherein the continuity anchor device is configured to prevent any such node from reconstructing plaintext continuity state or generating valid authorization artifacts even if the node operating system, hypervisor, or application layer is fully compromised.

15. The system of claim 1, wherein the governed release rule set supports granular delegation of sub-tokens with revocable, time-bound, and scope-limited rights for multi-user, family, or organizational sharing while preserving individual sovereignty, wherein delegation actions require anchor-local authorization artifact generation using non-exportable key material and are recorded in the encrypted audit log, and wherein the physically integrated secure processing enclave maintains a delegation revocation registry within the secure processing enclave, the registry being not readable, modifiable, or recoverable by any remote service, and wherein any sub-token appearing in the registry is denied restoration access regardless of continuity confidence threshold evaluation.

16. The system of claim 1, wherein the authorization artifact is cryptographically bound to a freshness value comprising at least one of a nonce generated by the physically integrated secure processing enclave, a monotonic counter value from a hardware-backed counter within the enclave, or a time-window parameter, such that replay of a previously verified artifact cannot authorize any subsequent continuity operation.

17. The system of claim 1, wherein at least one of: (i) the continuity anchor device is the exclusive root of trust for all continuity restoration, governed release, monetization authorization, and safety governance operations, and wherein no cloud infrastructure, remote service, or third-party operator is required or sufficient to serve as root of trust for any such operation; or (ii) the system operates equivalently across cloud-connected, intermittently connected, offline, air-gapped, vehicular, satellite, and neural-interface deployment environments, maintaining identical security properties and user sovereignty guarantees regardless of network availability.

18. The system of claim 1, wherein the continuity anchor device is implemented as a dedicated physical device that is physically separate and distinct from any heterogeneous user-interface node it serves, having no shared operating system, application processor, or memory space with any such node, and wherein the physically integrated secure processing enclave has no shared execution context or protected memory with any software executing outside the enclave boundary including the device operating system, hypervisor, and firmware update mechanisms.

19. A computer-implemented method for governed release, compliance enforcement, and sovereign monetization of continuity-based session restoration, executed by a continuity anchor device comprising a physically integrated secure processing enclave storing non-exportable key material that is not mirrored, escrowed, or re-hosted by any cloud-hosted key management service, the method comprising:
a) deriving a non-invertible continuity token from one or more biometric or interaction-derived signals or digital persona signatures combined with a device-specific or environment-specific secret value stored within the physically integrated secure processing enclave;
b) indexing encrypted continuity state data to the continuity token in an encrypted continuity state repository wherein decryption requires anchor-local authorization artifact generation using the non-exportable key material;
c) evaluating a governed release rule set to determine at least one disclosure constraint;
d) generating a least-disclosure continuity payload responsive to the governed release rule set;
e) generating and validating local authorization requests using non-exportable key material through a decentralized accountless authorization gateway without transmitting continuity material or biometric data externally;
f) enforcing metered consumption by tracking authorization credit consumption in a metering register stored exclusively within the physically integrated secure processing enclave;
g) monitoring biometric indicators and device tamper conditions using a safety governance layer and initiating cryptographic erasure of stored continuity tokens upon satisfaction of a safety revocation threshold; and
h) restoring continuity following an interruption event when a similarity metric between a re-derived continuity token and a stored reference continuity token satisfies a predefined continuity confidence threshold and when permitted by the governed release rule set and when no safety lock state is active,
wherein remote attestation evidence, by itself and absent satisfaction of on-device physical possession and liveness conditions, does not authorize continuity restoration or governed release, and wherein all operations are executable without network connectivity as a prerequisite.

20. The method of claim 19, further comprising enforcing a cryptographically locked freeze state during at least one of a safety event, compliance investigation, or tamper detection condition, the freeze state being releasable only upon anchor-local authorization artifact generation using non-exportable key material.

21. The method of claim 19, further comprising verifying a possession quorum condition requiring N of M registered physical continuity anchor devices to each independently generate a valid authorization artifact before authorizing a high-privilege operation.

22. The method of claim 19, further comprising executing a physical co-presence enrollment protocol to pre-enroll a successor anchor device, storing a recovery credential in the successor anchor device generated using the primary anchor's non-exportable key material during physical co-presence, without cloud-hosted recovery services or third-party key escrow.

23. The method of claim 19, further comprising selecting entitlement tiers based on locally validated cryptographic receipts and signed offline pricing manifests validated using non-exportable key material, enforcing tiered access to enhanced continuity features without centralized subscription management or cloud-hosted entitlement validation.

24. The method of claim 19, wherein all cryptographic operations utilize an algorithm-agile cryptographic module supporting runtime selection of classical, post-quantum, and hybrid classical plus post-quantum algorithm implementations without re-enrollment of biometric signals or cloud-side key migration.

25. A non-transitory computer-readable medium storing machine-executable instructions that, when executed by one or more processors of a continuity anchor device comprising a physically integrated secure processing enclave storing non-exportable key material that is not instantiable as, substitutable by, or satisfiable through any remote service, cloud-hosted execution environment, or network-accessible trusted execution environment, and that is not mirrored, escrowed, or re-hosted by any cloud-hosted key management service, cause the continuity anchor device to:
a) derive a non-invertible continuity token from one or more biometric or interaction-derived signals or digital persona signatures combined with a device-specific or environment-specific secret value stored within the physically integrated secure processing enclave;
b) index encrypted continuity state data to the continuity token in an encrypted continuity state repository wherein decryption requires anchor-local authorization artifact generation using the non-exportable key material;
c) evaluate a governed release rule set and generate a least-disclosure continuity payload responsive thereto;
d) generate authorization artifacts within the physically integrated secure processing enclave using the non-exportable key material, each artifact being cryptographically bound to the continuity token and the requested operation, bound to a freshness value comprising at least one of a nonce, monotonic counter value, or time-window parameter, and rendered invalid upon successful verification;
e) enforce metered consumption through a metering register stored exclusively within the physically integrated secure processing enclave, tracking monotonically incrementing consumption counters and enforcing throttle limits without network dependency;
f) enforce safety governance by monitoring biometric indicators and device tamper conditions, requiring active user consent, and initiating irreversible cryptographic erasure of stored continuity tokens and encrypted continuity memory upon safety revocation threshold satisfaction; and
g) restore continuity when a similarity metric satisfies a predefined continuity confidence threshold and when permitted by the governed release rule set and when no safety lock state is active,
wherein remote attestation evidence, cloud-hosted key management services, centralized identity providers, and remote commands are each insufficient by themselves to authorize continuity restoration, governed release, entitlement modification, or safety lock release absent anchor-local authorization artifact generation using non-exportable key material under exclusive cryptographic control of the physically integrated secure processing enclave.

26. The non-transitory computer-readable medium of claim 25, wherein the instructions further cause the continuity anchor device to enforce possession quorum conditions requiring N of M physical continuity anchor devices to each independently generate valid authorization artifacts before authorizing high-privilege operations.

27. The non-transitory computer-readable medium of claim 25, wherein the instructions further cause the continuity anchor device to execute physical co-presence successor anchor enrollment and to authorize re-derivation of continuity tokens using a recovery credential upon loss of the primary anchor, without cloud-hosted recovery services.

28. The non-transitory computer-readable medium of claim 25, wherein the instructions further cause the continuity anchor device to execute all cryptographic operations using an algorithm-agile cryptographic module supporting post-quantum primitives and hybrid classical plus post-quantum modes, enabling cryptographic algorithm transitions over a twenty-year operational horizon without re-enrollment or cloud-side key migration.

29. The non-transitory computer-readable medium of claim 25, wherein the instructions further cause the continuity anchor device to generate zero-knowledge proofs demonstrating compliance with governed release rule sets or satisfaction of entitlement conditions without disclosing restricted continuity state, biometric signals, or non-exportable key material to external verifiers.

30. The non-transitory computer-readable medium of claim 25, wherein the instructions further cause the continuity anchor device to enforce dual-anchor guardian unlock requiring both a primary continuity anchor device and a pre-enrolled guardian anchor device to each generate valid authorization artifacts for release of a safety lock state.
